(19) United States
(12) Patent Application Publication
(10) Pub. No.: US 2026/0332305 A1
(43) Pub. Date: Oct. 22, 2026

(54) PDU SET BASED RLC RETRANSMISSION

(71) Applicant: Apple Inc., Cupertino, CA (US)

(72) Inventors: Fangli Xu, Beijing (CN); Ralf Rossbach, Munich (DE); Ping-Heng Kuo, London (GB); Haijing Hu, Los Gatos, CA (US)

(73) Assignee: Apple Inc., Cupertino, CA (US)

(21) Appl. No.: 19/102,339

(22) PCT Filed: Aug. 8, 2022
(86) PCT No.: PCT/CN2022/110903

§ 371 Date: Feb. 7, 2025

(51) Int. Cl. H04L 1/08

(52) U.S. Cl. CPC H04L 1/08

(57) ABSTRACT

Provided is a method for a first communication device. The method includes obtaining a first protocol data unit (PDU) set comprising multiple Radio Link Control (RLC) PDUs for transmission to a second communication device; in response to a determination that a first criterion is met for the first PDU set, identifying, from the first PDU set, at least one PDU for retransmission; and triggering an RLC retransmission for the at least one PDU to the second communication device.

### TECHNICAL FIELD

This application relates generally to wireless communication systems, and more specifically to protocol data unit (PDU) set based Radio Link Control (RLC) Retransmission.

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### SUMMARY

According to an aspect of the present disclosure, provided is a method for a first communication device, including: obtaining a first protocol data unit (PDU) set comprising multiple Radio Link Control (RLC) PDUs for transmission to a second communication device; in response to a determination that a first criterion is met for the first PDU set, identifying, from the first PDU set, at least one PDU for retransmission; and triggering an RLC retransmission for the at least one PDU to the second communication device.

According to an aspect of the present disclosure, provided is an apparatus that includes one or more processors configured to perform steps of the method according to the present disclosure.

According to an aspect of the present disclosure, a computer readable medium is provided that has computer programs stored thereon, which when executed by one or more processors, cause an apparatus to perform steps of the method according to perform steps of the method according to the present disclosure.

According to an aspect of the present disclosure, a computer program product is provided that includes computer programs which, when executed by one or more processors, cause an apparatus to perform steps of the method according to the present disclosure.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2 illustrates a flowchart for an exemplary method for a user equipment in accordance with some embodiments.

FIG. 3 illustrates an exemplary diagram for XR traffic transmission.

FIG. 4A-FIG. 4F illustrate exemplary diagrams of RLC transmission and retransmission according to embodiments of the present disclosure

FIG. 5 illustrates an exemplary block diagram of an apparatus for a communication device in accordance with some embodiments.

FIG. 6 illustrates example components of a device in accordance with some embodiments.

FIG. 7 illustrates example interfaces of baseband circuitry in accordance with some embodiments.

FIG. 8 illustrates components in accordance with some embodiments.

FIG. 9 illustrates an architecture of a wireless network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

In wireless communication, 3GPP will study enhancements to better support XR. XR Enhancement involves several objectives. For XR/media services, a group of packets may be used to carry payloads (e.g., a frame, video slice/tile). A protocol data unit (PDU) set may be used, which is composed of one or more PDUs carrying the payload of one unit of information generated at the application level (e.g., a frame or video slice for XRM Services), which are of same importance at application layer.

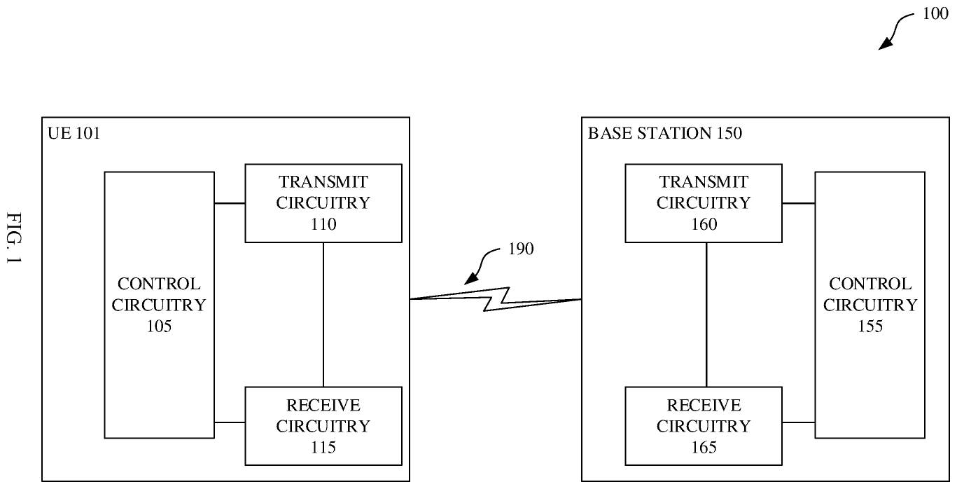

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120-degree area with an array of antennas directed to each sector to provide 360-degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuitry 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g., messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person-to-person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is included of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is included of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

The UE and the network device described in the following embodiments may be implemented by the UE 101 and the base station 150 described in FIG. 1.

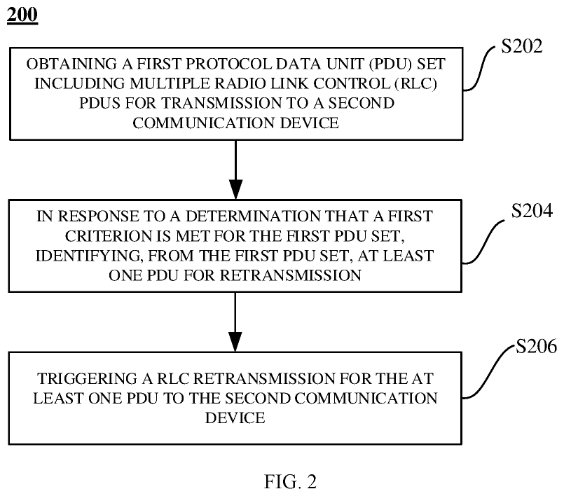

FIG. 2 illustrates a flowchart for an exemplary method for a first communication device in accordance with some embodiments. The method 200 illustrated in FIG. 2 may be implemented by the UE 101 described in FIG. 1. The method 200 illustrated in FIG. 2 may also be implemented by the base station 150 described in FIG. 1.

In some embodiments, the method 200 for UE may include the following steps: S202, obtaining a first protocol data unit (PDU) set including multiple Radio Link Control (RLC) PDUs for transmission to a second communication device; S204, in response to a determination that a first criterion is met for the first PDU set, identifying, from the first PDU set, at least one PDU for retransmission; and S206, triggering an RLC retransmission for the at least one PDU to the second communication device.

According to some embodiments of the present disclosure, RLC retransmission can be triggered for RLC PDU set to improve the PDU set level reliability.

The current 5G Core (5GC) network involves, among others, the following traffic characteristics that the Quality of service (QoS) Flow is the finest granularity of QoS differentiation in the PDU Session. The 5G QoS characteristics is determined by the 5G QoS Identifier (5QI). This implies that each packet in a QoS flow is treated according to the same QoS requirements. The QoS handling including QoS parameters maintenance, retransmission and QoS scheduling in MAC is applied per packet/PDU.

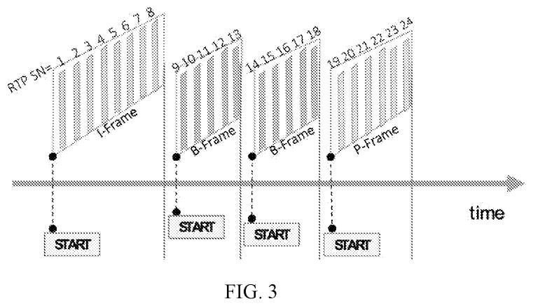

FIG. 3 illustrates an example XR traffic. There are some new traffic characteristics for XR. As can be seen from FIG. 3, each of the I-Frame, B-Frame and P-Frame may be transmitted by a separate PDU set (or sets). In some cases, all PDUs in a PDU set are needed by APP layer to use the corresponding unit of information. In some cases, the APP layer can still recover parts of the information unit, when some PDUs are missing. The QoS handling including QoS parameters maintenance, retransmission and QoS scheduling in MAC may be applied per PDU set.

According to some of the retransmission scheme, potential problems lie in that as the QoS requirement is per PDU set for the XR service, and all PDUs in a PDU Set are needed by APP layer to use the corresponding unit of information, thus it is possible that some PDUs in the set is transmitted successfully but others are not within the valid time period, which means the transmission of the entire PDU set fails. Other drawbacks may include that PDUs that are transmitted successfully are meaningless, and the radio resources are wasted, or that the PDU set level QoS requirement cannot be fulfilled well.

Proposed are some potential enhancements to introduce PDU set based PDU retransmission scheme, mainly from RLC layer, in order to improve the PDU set level reliability.

In the following, each step of the method 200 will be described in details.

At step S202, a first protocol data unit (PDU) set including multiple Radio Link Control (RLC) PDUs for transmission to a second communication device is obtained.

According to some embodiments of the present disclosure, the RLC Retransmission scheme can be performed in the transmission side. In some embodiment, the first communication device can be a UE, and the second communication device can be a base station device, such as but not limited to a gNodeB device. In some other embodiment, the first communication device can be a base station device, and the second communication may be a UE or another device. In some embodiment, the second communication may be the network. It can be understood that the disclosure is not limited thereto.

It can be understood that obtaining a first PDU set for transmission may mean to generate, to modify, to receive, to determine, to identify, or to otherwise obtain the PDU set, and the disclosure is not limited thereto.

At step S204, in response to a determination that a first criterion is met for the first PDU set, at least one PDU for retransmission is identified from the first PDU set.

As will be further described below, the first criterion may include one or more criterion, and that a first criterion is met may mean at least one of the one or more criterion at least one, at least two of the one or more criterion are met, all of the one or more criterion are met, etc., and the disclosure is not limited thereto.

Identifying the at least one PDU for retransmission may include determining, receiving, generating or otherwise obtaining the number, the identifier or other possible identification (ID) of the at least one PDU, such as determining that or receiving an indication that “the #3 or #5 PDU of a certain PDU set needs to be retransmitted”. Identifying the at least one PDU for retransmission may include receiving, generating, regenerating or otherwise obtaining the at least one PDU packet that needs to be transmitted. It can be understood that those are merely examples and the disclosure is not limited thereto.

At step S206, an RLC retransmission for the at least one PDU to the second communication device is triggered.

Triggering an RLC retransmission may include generating an instruction or command for retransmission, causing, configuring, reconfiguring or otherwise preparing for the retransmission. Triggering an RLC does not necessarily mean that the RLC retransmission has to be initialized at the time of triggering.

In some embodiments, the first criterion may be set to indicate that a PDU of a certain order of the PDU set is transmitted. In such embodiments, the first criterion may include at least one of the following: that an N^{th} PDU of the first PDU set has been transmitted, or that an M^{th} last PDU of the first PDU set has been transmitted.

In such embodiments, N may be a positive integer that is smaller than the size of the first PDU set, and/or M may be a positive integer that is smaller than the size of the first PDU set. Therefore, the retransmission can be triggered after the start of transmission and before the transmission is finished. In the cases where transmission and retransmission for a particular PDU set has to be done within a certain valid time period, triggering a retransmission before the end of the transmission can be especially beneficial.

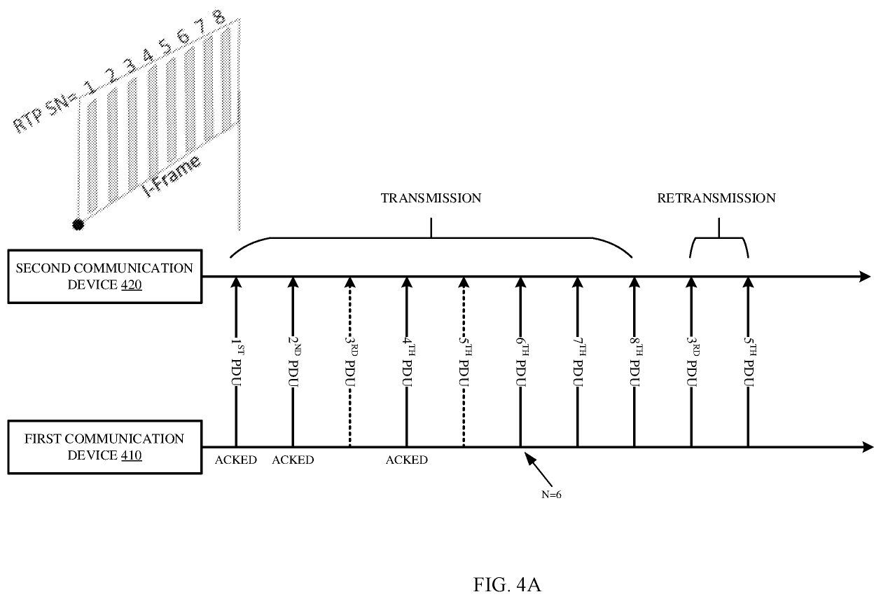

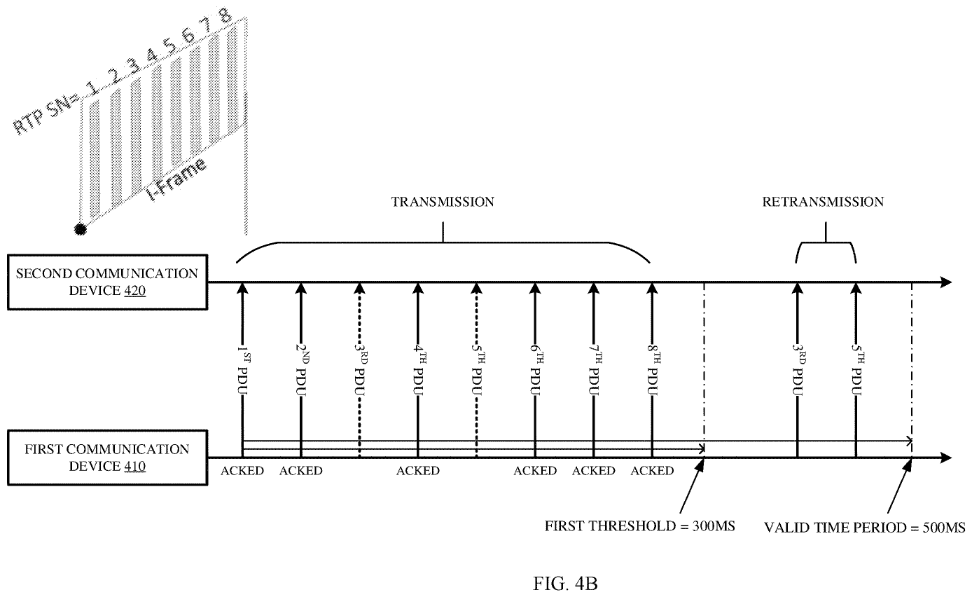

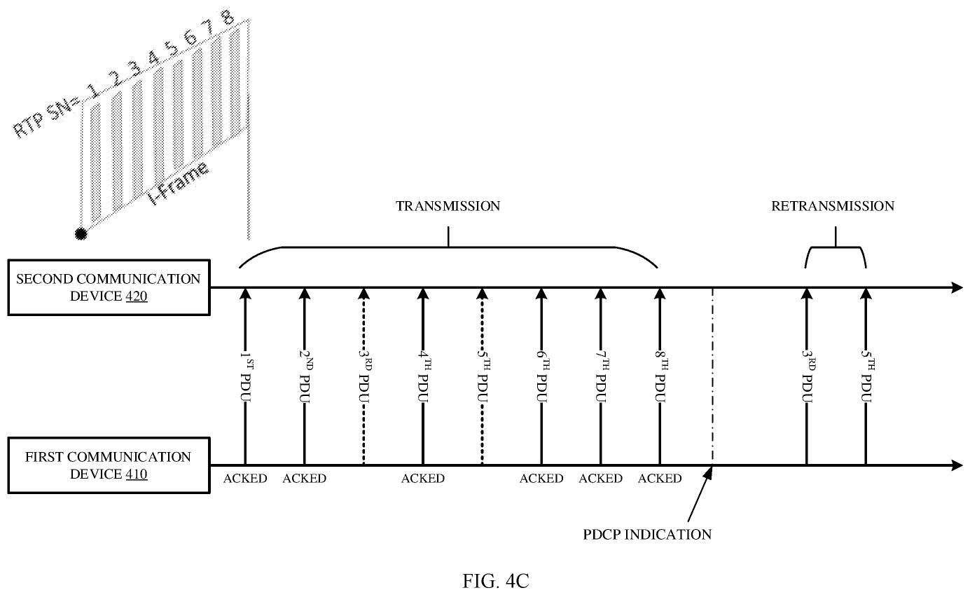

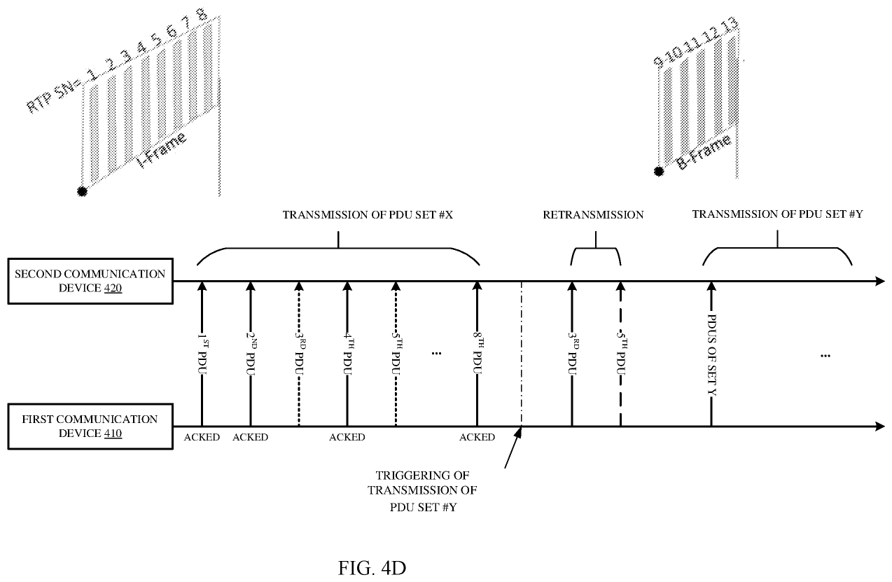

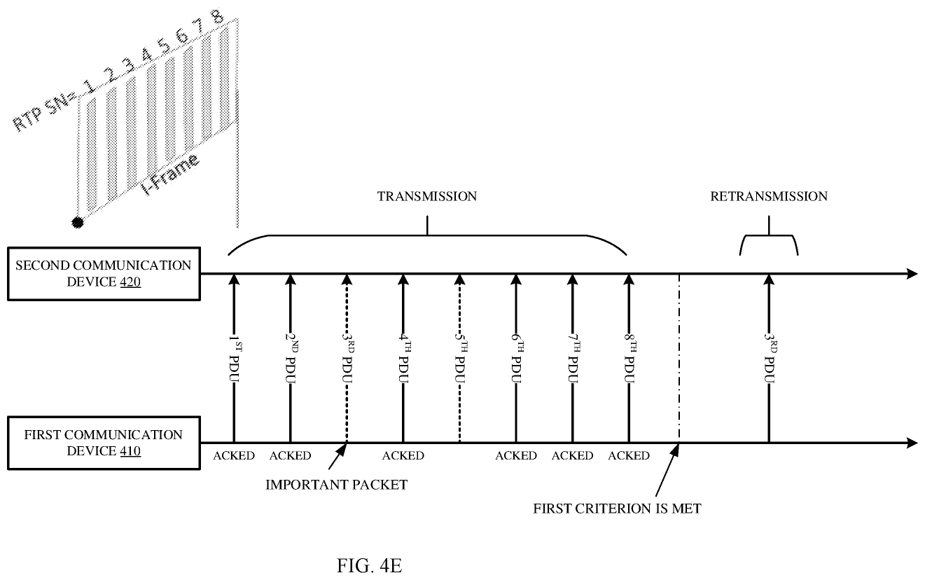

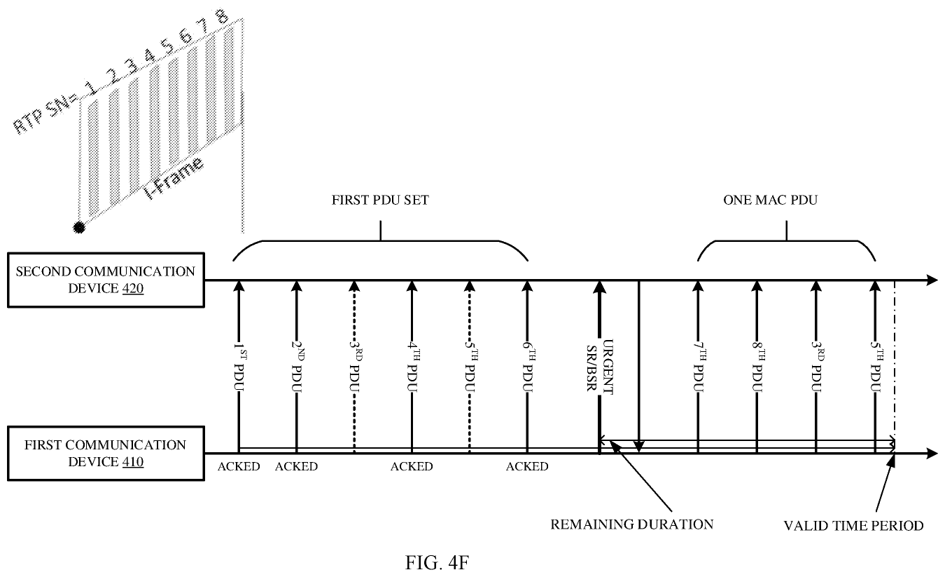

FIG. 4A illustrates an example scenario of the embodiment. As can be seen from FIG. 4A, the first communication device 410 is configured to transmit, to a second communication device 420, a PDU set corresponding to a I-Frame, for which the Real-time Transport Protocol (RTP) sequence number (SN) is 1, 2, 3, 4, 5, 6, 7, and 8. In other words, the size of a PDU set is 8. In this case, the value of N is set to be equal to 6, and it can be understood by those skilled in the art that the disclosure is not limited thereto. Based on this example configuration, the transmitting side of the RLC entity can trigger the RLC PDU retransmission when the 6th RLC PDU of the PDU set has been, is being, or is initiated to be transmitted.

In some optional embodiment that will be describe in detail below, when the first criterion is met, the transmitting side of the RLC entity may check and determine which PDUs of the PDU set need to be retransmitted. For example, the RLC entity may check the status of feedbacks of each of the PDU, and determines the PDU(s) for which no ACK feedback has been received as those to be retransmitted, or as the “at least one PDU for retransmission” as recited in step S204. As will be described in further details below, an ACK feedback hereby does not necessarily have to be a RLC ACK, but rather can include any kind of explicit or implicit feedback or signal from the other communication device, as long as the feedback or signal indicates or implies that the corresponding PDU packet is being or has been received by the other communication device. In some other embodiments, the PDUs of the PDU set need to be retransmitted can be otherwise identified, such as by another entity rather than the RLC entity, by two or more layers in combination, or even by (or taking consideration of a retransmission decision of) the receiving side, and the disclosure is not limited thereto.

For example, referring to FIG. 4A, at the timing that the 6th RLC PDU of the PDU set has been be transmitted, the first communication can check feedback status for each of the PDU from the 1 st PDU to the 5th or the 6th PDU, and may find out that for the 3rd and 5th PDUs, no ACK feedback has been received. Therefore, retransmission of the 3rd and 5th PDU can be triggered.

It can be understood that the expression of “an N^{th} PDU of the first PDU set has been transmitted” or “an M^{th} last PDU of the first PDU set has been transmitted” does not necessarily require that the N^{th} or the M^{th} last PDU be fully transmitted to trigger the retransmission. In some examples, when the N^{th} or the M^{th} last PDU is triggered or initiated to be transmitted, the first criterion can be regarded as being satisfied. In some other examples, the first criterion may be regarded as being satisfied upon or shortly after the start of transmission or the complement of transmission, of the N^{th} or the M^{th} last PDU.

In some cases, within a PDU set, new transmissions may have a higher priority than a triggered retransmissions such as a retransmission triggered by some of the conditions or criteria disclosed hereby. In such cases, if the retransmission is triggered for a certain PDU, and an ACK for that certain PDU is received after the triggering but before the retransmission is actually performed, the first communication device such as the UE will regard the PDU as being successfully transmitted and cancel the retransmission therefor. This optional solution will be described in detail below.

The configuration including the value of number N and/or M may be pre-configured by the network. The value of number N and/or M may be pre-stored in the first communication device. In some other embodiments, the value of number N and/or M be obtained or updated by the first communication device upon reception of a configuration or reconfiguration signal from e.g., the other communication device and/or from the network.

Additionally, or alternatively, the retransmission may be triggered when the current transmission duration of current PDU set exceeds a threshold. In some embodiments, the first criterion may include at least one of the following: that a time of a first threshold has lapsed after a start point of the transmission of the first PDU set, wherein the first threshold is less than a valid time period for the transmission of the first PDU set; or that a remaining duration for the transmission of the first PDU set has fallen below a second threshold, wherein the second threshold is great than zero and less than the valid time period for the transmission of the first PDU set.

According to such embodiments, the transmission can be finished before the valid time expires to avoid potential risk of retransmission failure.

The valid time period may be known by the communication device such as a UE. This configuration may be pre-configured or configured by the network, or otherwise obtained or received by the first communication device.

FIG. 4B illustrates a specific and unlimiting example, where the valid time period may be 500 ms, and the first threshold may be 300 ms. In this example, when the transmission duration of the current PDU set transmission >300 ms, the first communication device such as a UE or a gNB may trigger a the RLC retransmission. In some other examples, the first threshold may be 200 ms, 250 ms, 400 ms, 50% of a preset valid time period, 60% of the valid time period, 70% of the valid time period, etc. Alternatively, the second threshold may be 200 ms, 150 ms, 100 ms, 30% of a preset valid time period, 40% of the valid time period, 60% of the valid time period, etc. It can be understood that the values of valid time period and thresholds hereby are examples and the disclosure is not limited thereto.

Similar to those described above, new transmissions within a PDU set may optionally have a higher priority than a triggered retransmissions such as a retransmission triggered by some of the conditions or criteria disclosed hereby. In such cases, if the retransmission is triggered for a certain PDU, and an ACK for that certain PDU is received after the triggering but before the retransmission is actually performed, the first communication device such as the UE or the gNB will regard the PDU as being successfully transmitted and cancel the retransmission therefor.

In some embodiments, the first criterion may include a number of ACK feedbacks received for the first PDU set is below a third threshold.

When the number of ACK feedbacks for a transmitted PDU set is below a certain value, it is indicated that the number of PDUs in the PDU set that are successfully received in the other side may be relatively low. Therefore, a retransmission may be needed in this case.

Additionally, or alternatively, this criterion may be combined with other criteria. For example, the first criterion may include that when some other conditions described hereby are met and the number of acknowledged (ACKed) PDU packets has not reached a threshold. As can be known by those skilled in the art, an ACKed PDU may mean a PDU packet for which an ACK feedback has been received, and the ACK feedback may include explicit or implicit ones and is not limited to one through the RLC layer. For example, the first criterion may be satisfied when at the timing that the 6th RLC PDU of the PDU set has been be transmitted and/or at the timing when the first threshold has lapsed, the number of ACKed packets is less than 2, less than 3, or etc. For another example, the first may be satisfied when the number of ACKed packets while some other criterion described below is met—e.g., when there is a retransmission indication from another layer instead of the RLC, and the number of ACKed packet is less than 2, less than 3, or etc.

The retransmission indication may be from an upper layer such as a Packet Data Convergence Protocol (PDCP) layer. In such cases, the upper layer/PDCP layer may indicate, along with the retransmission indication, the certain PDU(s) to be retransmitted. This may include cases where the PDCP layer indicates a particular PDU set, where the PDCP layer indicates a start PDCP PDU for RLC retransmission, and/or where the PDCP layer indicates multiple PDCP PDUs for RLC retransmission within the PDU set. In such cases, the valid time period for one PDU set transmission may be additionally or alternatively maintained in PDCP layer to ensure the retransmission is triggered within the valid time period and to avoid potential transmission or retransmission failure due to timeout.

In some embodiments, the first criterion may include that a retransmission indication specifying the first PDU set is obtained from a Packet Data Convergence Protocol (PDCP) layer.

Referring to FIG. 4C for example, where a PDCP indication triggers the retransmission of the shown particular PDU set. The first communication device may then identify or determine which PDU(s) in the particular PDU set (in the shown examples, the 3rd and the 5th PDUs) shall be retransmitted, and trigger retransmission for the identified PDU(s).

In some additional or alternative embodiments, the first criterion may include that a transmission or a retransmission is triggered for a second PDU set having dependency with the first PDU set.

Retransmission triggered by the transmission of other PDU set may be based on an assumption that there are inter-dependency between different PDU Sets. In such cases, the transmitter may also determine if autonomous retransmission should be conducted based on the status of the other PDU set(s).

Referring to FIG. 4D for example, where a PDU set #X corresponding to the I-Frame has dependency with a PDU set #Y corresponding to the B-Frame. In such a scenario, the first communication device 410 and optionally the transmitting side of the RLC entity may know the dependency by configuration and so on. If the transmission or the retransmission of the packet in PDU set #Y is triggered or initiated, the transmitting device or the transmitting RLC entity may determine that a first criterion is met for the associated PDU set #X. Therefore, the RLC may initiate an RLC retransmission for the 3rd PDU and/or the 5th PDU of the PDU set #X.

It can be understood that under circumstances where PDUs or PDU sets have different importance flags or priorities, the packet of PDU set #Y could be an important packet, or could be of any importance level or priorities, to trigger the retransmission of PDU set #X.

As already discussed above and will be further discussed below, after the triggering of transmission of PDU set #Y, the transmitter may identify which PDU(s) in the associated PDU set #X is/are to be retransmitted. For example, it may be determined that the packets #3 and #5 of the PDU set #X have not been ACKed or otherwise have not been transmitted, and therefore, for the 3rd and 5th PDU in the PDU set, a retransmission may be triggered. For another example, if the 3rd PDU is an important packet, while the 5th PDU is not an important packet, the first communication device 410 may trigger a retransmission for the 3rd PDU, but not for the 5th PDU, to save bandwidth and/or resources.

As already discussed above, in some embodiments, identifying at least one PDU for retransmission may include: identifying a PDU from the first PDU set, for which no acknowledge (ACK) feedback is received, as a PDU for retransmission.

Such a solution applies especially to cases where all packets within a PDU set (or optionally, within several or all PDU sets) have equal priority.

In some other embodiments, it is assumed that one or more packets within one PDU set have higher priority (more important) than others. Under such circumstances, retransmission may be triggered by an important PDU in a PDU set. In other words, the retransmission condition and/or retransmitted PDU selection may be only applicable on the important packets.

The importance or priority can be indicated or allocated by the first communication device, by the second device, or by other devices in the network, etc. The importance or priority can be generated by the first communication device, or can be otherwise identified by the first communication device. For example, the RLC entity may recognize an important packet by means of an important indication together with each RLC SDU which is indicated by PDCP layer.

In this situation, the first criterion is met, e.g., when at least one of other conditions described hereby is met, and/or when there is at least one important RLC PDU for which no ACK feedback has been received.

After the first criterion is satisfied, the first communication device such as a UE or a gNB may identifies all the RLC PDU(s) which is/are not ACKed as the at least one PDU for retransmission, and trigger the RLC retransmission for all the non-ACKed RLC PDUs.

Optionally, the first communication device such as a UE or a gNB may only identifies the important RLC PDU(s) which is/are not ACKed as the at least one PDU for retransmission and trigger the RLC retransmission therefor.

As an exemplary embodiment, identifying at least one PDU for retransmission may include: in a case that the multiple PDUs have different priorities, identifying a PDU from the first PDU set and satisfying at least one of the following as a PDU for retransmission: the PDU is of a higher priority, the PDU has an important flag, or for the PDU no ACK feedback is received. As shown in FIG. 4E, upon the satisfying of the first criterion, it is determined that an important RLC PDU (3rd PDU) and a non-important RLC PDU (5th PDU) have not been ACKed. Thereafter, a retransmission is triggered for the important 3rd PDU, but not for the non-important 5th PDU. As a more specific yet non-limiting example, the first criterion may be that the first PDU set is indicated to be retransmitted by a PDCP layer, and the RLC may determine that for the first PDU set, there is an important RLC PDU for which no ACK feedback has not been received, and then trigger the retransmission for the 3rd PDU accordingly.

As also discussed above, in some cases, In such cases, if an ACK for an identified non-ACKed PDU is received before the retransmission is actually performed, the retransmission for that PDU may be cancelled. In other words, triggering a retransmission for the at least one PDU may additionally or alternatively include causing the retransmission to be performed after a completion of the transmission of the first PDU set; and the method further including: in response to receiving an ACK feedback for a first PDU of the at least one PDU before retransmitting of the first PDU, forgoing the initiating of the retransmission for the first PDU.

In some examples, some RLC PDU retransmission schemer for Acknowledged Mode (AM) mode may include triggering the RLC PDU retransmission if a NACK is received in the RLC status report from peer entity; and/or if a t-PollRetransmit timer expires, the RLC with highest SN may be retransmitted in order to include P bit. However, such RLC PDU retransmission scheme fails to cover the RLC Unacknowledged Mode (UM) mode. Thus, further provided hereby are some optional embodiments to achieve RLC retransmission based on the PDU set transmission condition for both RLC AM and UM mode.

In some embodiments, the ACK feedback for a PDU may include, for an RLC AM mode, an RLC ACK, an explicit ACK for a Hybrid Automatic Repeat Request (HARQ) transmission corresponding to the PDU, or an implicit ACK for the HARQ transmission corresponding to the PDU. In some additional or alternative embodiments, the ACK feedback for a PDU may include, for an RLC UM mode, an explicit ACK for a Hybrid Automatic Repeat Request (HARQ) transmission corresponding to the PDU, or an implicit ACK for the HARQ transmission corresponding to the PDU. It can be seen to those skilled in the art that the explicit and/or implicit ACK for the corresponding HARQ transmission can also be identified as a MAC ACK and the disclosure is not limited thereto.

By taking other forms of explicit or implicit ACKs into consideration, the proposed RLC retransmission solution can apply to, not only the RLC AM mode, but also to other modes such as an RLC UM mode. Therefore, steadier and more desired RLC transmission can be obtained.

Examples are given where the operation of identifying at least one PDU for retransmission from the first PDU set are done by an RLC entity. It can be seen that in some other embodiments, the identification or decision can be made, at least partly, by other entities or other sides.

As an exemplary embodiment, the first criterion may include that a retransmission indication specifying a start PDU is obtained from a Packet Data Convergence Protocol (PDCP) layer. In such embodiments, identifying the at least one PDU for retransmission may include: identifying a PDU, starting from the start PDU and within the first PDU set, for which no acknowledge (ACK) feedback is received, as a PDU for retransmission.

This situation can be combined with the assumption where PDUs are indicated or allocated with different priorities. As another optional and unlimiting example, the first criterion may include that a retransmission indication specifying a start PDU is obtained from a Packet Data Convergence Protocol (PDCP) layer, and wherein identifying at least one PDU for retransmission may include: in a case that RLC Service data units (SDUs) corresponding to the multiple PDUs are indicated with different priorities, identifying a PDU starting from the start PDU and within the first PDU set and satisfying at least one of the following as a PDU for retransmission: the PDU is of a higher priority, the PDU has an important flag, or for the PDU no ACK feedback is received.

Optionally, the at least one PDU for retransmission can be identified by a PDCP layer or another upper layer. In other words, the first criterion may alternatively include that a retransmission indication specifying one or more PDU is obtained from a Packet Data Convergence Protocol (PDCP) layer, and wherein identifying the at least one PDU for retransmission may include identifying the one or more PDU specified in the retransmission indication as the at least one PDU for retransmission. In such circumstance, the transmission entity may make the retransmission decision, and feedbacks from the receiving entity could also be taken into account.

In some embodiments, triggering an RLC retransmission for the at least one PDU may include: triggering the retransmission immediately, or triggering the retransmission upon an expiration of a t-PollRetransmit timer. The t-PollRetransmit timer may be configured by RRC to indicate the AM Transmission RLC entity in order to retransmit a poll.

Also proposed hereby are some solutions for urgent scheduled request. It can be understood that under some circumstances, there is no UL grant, and a UE/gNB still have data in the buffer, possibly for new transmission or for retransmission. In such cases, the UE/gNB can trigger a special BSR/SR as the urgent transmission request.

In some embodiments, the method may further include in a case that there is no UL grant and that the first PDU set is indicated as urgent, transmitting, to the second communication device, a Scheduling Request (SR), a Buffer Status Report (BSR) or an MAC CE as an urgent request before the expiration of a valid time period set for the transmission of the first PDU set.

For the urgent SR, it may be a dedicated SR resource configured for the urgent request.

For the urgent BSR, it may include at least one of a channel information, a data amount, or a remaining duration to indicate, e.g., the amount of data to be transmitted or retransmitted, the number of PDUs, the remaining valid time, etc.

An example configuration of an urgent request is illustrated in Table 1 below.

TABLE 1
Urgent Request
LCH ID

BS info
(the data amount of 3/5/7/8 PDU)
The remaining duration (i.e., 200 ms)
(From SR/BSR transmission to end-time)

As illustrated in FIG. 4F, an urgent SR or BSR is transmitted from the first communication device, e.g., to the network. This may be triggered, e.g., by PDCP PDU indicating the urgent transmission indication for the shown first PDU set. Regarding the RLC operation, at this time and for the first PDU set, the 7th and 8th PDUs may have not been transmitted, and 3rd and 5th PDU are not ACKed or are otherwise identified as to be retransmitted. In this example, the RLC may indicates the MAC entity to send an urgent SR request, and the MAC may transmit the special SR or BSR accordingly.

The Urgent Request may also indicate the remaining duration (e.g., 200 ms) before the valid time period (e.g., 500 ms) expires so that the UL grant can be in time and that the transmission and/or retransmission can be done within the valid time period.

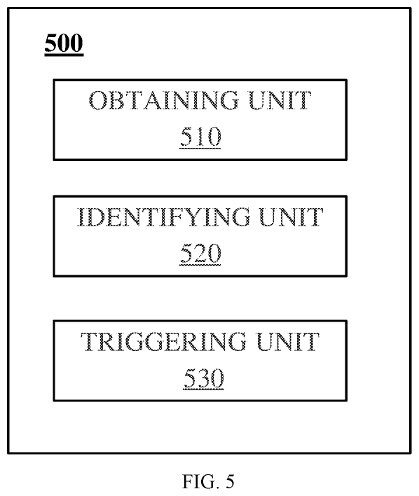

FIG. 5 illustrates an exemplary block diagram of an apparatus for a communication in accordance with some embodiments. The apparatus 500 illustrated in FIG. 5 may be used to implement the method 200 as illustrated in combination with FIG. 2 and/or any modifications thereof.

As illustrated in FIG. 5, the apparatus 500 includes an obtaining unit 510, an identifying unit 520, and a triggering unit 530.

The obtaining unit 510 may be configured to obtain a first protocol data unit (PDU) set including multiple Radio Link Control (RLC) PDUs for transmission to a second communication device.

The identifying unit 520 may be configured to identify, in response to a determination that a first criterion is met for the first PDU set and from the first PDU set, at least one PDU for retransmission.

The triggering unit 530 may be configured to trigger an RLC retransmission for the at least one PDU to the second communication device.

According to the embodiments of the present application, RLC retransmission can be triggered for RLC PDU set to improve the PDU set level reliability.

According to some aspect of the disclosure, also provided are a computer readable medium having computer programs stored thereon and a computer program product including computer programs which, when executed by one or more processors, cause an apparatus to perform steps of the method according to the embodiments hereby.

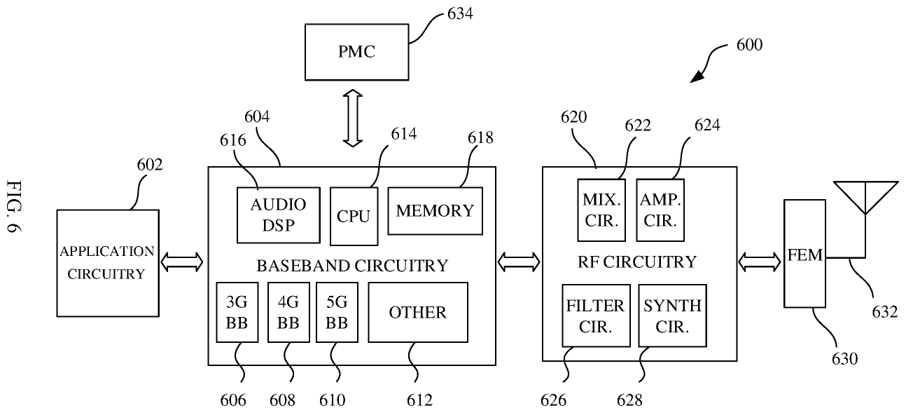

FIG. 6 illustrates example components of a device 600 in accordance with some embodiments. In some embodiments, the device 600 may include application circuitry 602, baseband circuitry 604, Radio Frequency (RF) circuitry (shown as RF circuitry 620), front-end module (FEM) circuitry (shown as FEM circuitry 630), one or more antennas 632, and power management circuitry (PMC) (shown as PMC 634) coupled together at least as shown. The components of the illustrated device 600 may be included in a UE or a RAN node. In some embodiments, the device 600 may include fewer elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 620 and to generate baseband signals for a transmit signal path of the RF circuitry 620. The baseband circuitry 604 may interface with the application circuitry 602 for generation and processing of the baseband signals and for controlling operations of the RF circuitry 620. For example, in some embodiments, the baseband circuitry 604 may include a third generation (3G) baseband processor (3G baseband processor 606), a fourth generation (4G) baseband processor (4G baseband processor 608), a fifth generation (5G) baseband processor (5G baseband processor 610), or other baseband processor(s) 612 for other existing generations, generations in development or to be developed in the future (e.g., second generation (2G), sixth generation (6G), etc.). The baseband circuitry 604 (e.g., one or more of baseband processors) may handle various radio control functions that enable communication with one or more radio networks via the RF circuitry 620. In other embodiments, some or all of the functionality of the illustrated baseband processors may be included in modules stored in the memory 618 and executed via a Central Processing ETnit (CPET 614). The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include a digital signal processor (DSP), such as one or more audio DSP(s) 616. The one or more audio DSP(s) 616 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 604 is configured to support radio communications of more than one wireless protocol may be referred to as multi-mode baseband circuitry.

The RF circuitry 620 may enable communication with wireless networks using modulated electromagnetic radiation through a non-solid medium. In various embodiments, the RF circuitry 620 may include switches, filters, amplifiers, etc. to facilitate the communication with the wireless network. The RF circuitry 620 may include a receive signal path which may include circuitry to down-convert RF signals received from the FEM circuitry 630 and provide baseband signals to the baseband circuitry 604. The RF circuitry 620 may also include a transmit signal path which may include circuitry to up-convert baseband signals provided by the baseband circuitry 604 and provide RF output signals to the FEM circuitry 630 for transmission.

In some embodiments, the receive signal path of the RF circuitry 620 may include mixer circuitry 622, amplifier circuitry 624 and filter circuitry 626. In some embodiments, the transmit signal path of the RF circuitry 620 may include filter circuitry 626 and mixer circuitry 622. The RF circuitry 620 may also include synthesizer circuitry 628 for synthesizing a frequency for use by the mixer circuitry 622 of the receive signal path and the transmit signal path. In some embodiments, the mixer circuitry 622 of the receive signal path may be configured to down-convert RF signals received from the FEM circuitry 630 based on the synthesized frequency provided by synthesizer circuitry 628. The amplifier circuitry 624 may be configured to amplify the down-converted signals and the filter circuitry 626 may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a requirement. In some embodiments, the mixer circuitry 622 of the receive signal path may include passive mixers, although the scope of the embodiments is not limited in this respect.

In some embodiments, the mixer circuitry 622 of the transmit signal path may be configured to up-convert input baseband signals based on the synthesized frequency provided by the synthesizer circuitry 628 to generate RF output signals for the FEM circuitry 630. The baseband signals may be provided by the baseband circuitry 604 and may be filtered by the filter circuitry 626.

In some embodiments, the mixer circuitry 622 of the receive signal path and the mixer circuitry 622 of the transmit signal path may include two or more mixers and may be arranged for quadrature downconversion and upconversion, respectively. In some embodiments, the mixer circuitry 622 of the receive signal path and the mixer circuitry 622 of the transmit signal path may include two or more mixers and may be arranged for image rejection (e.g., Hartley image rejection). In some embodiments, the mixer circuitry 622 of the receive signal path and the mixer circuitry 622 may be arranged for direct downconversion and direct upconversion, respectively. In some embodiments, the mixer circuitry 622 of the receive signal path and the mixer circuitry 622 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 620 may include analog-to-digital converter (ADC) and digital-to-analog converter (DAC) circuitry and the baseband circuitry 604 may include a digital baseband interface to communicate with the RF circuitry 620.

In some dual-mode embodiments, a separate radio IC circuitry may be provided for processing signals for each spectrum, although the scope of the embodiments is not limited in this respect.

In some embodiments, the synthesizer circuitry 628 may be a fractional-N synthesizer or a fractional N/N+1 synthesizer, although the scope of the embodiments is not limited in this respect as other types of frequency synthesizers may be suitable. For example, synthesizer circuitry 628 may be a delta-sigma synthesizer, a frequency multiplier, or a synthesizer including a phase-locked loop with a frequency divider.

The synthesizer circuitry 628 may be configured to synthesize an output frequency for use by the mixer circuitry 622 of the RF circuitry 620 based on a frequency input and a divider control input. In some embodiments, the synthesizer circuitry 628 may be a fractional N/N+1 synthesizer.

In some embodiments, frequency input may be provided by a voltage controlled oscillator (VCO), although that is not a requirement. Divider control input may be provided by either the baseband circuitry 604 or the application circuitry 602 (such as an applications processor) depending on the desired output frequency. In some embodiments, a divider control input (e.g., N) may be determined from a look-up table based on a channel indicated by the application circuitry 602.

Synthesizer circuitry 628 of the RF circuitry 620 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 628 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 620 may include an IQ/polar converter.

The FEM circuitry 630 may include a receive signal path which may include circuitry configured to operate on RF signals received from one or more antennas 632, amplify the received signals and provide the amplified versions of the received signals to the RF circuitry 620 for further processing. The FEM circuitry 630 may also include a transmit signal path which may include circuitry configured to amplify signals for transmission provided by the RF circuitry 620 for transmission by one or more of the one or more antennas 632. In various embodiments, the amplification through the transmit or receive signal paths may be done solely in the RF circuitry 620, solely in the FEM circuitry 630, or in both the RF circuitry 620 and the FEM circuitry 630.

In some embodiments, the FEM circuitry 630 may include a TX/RX switch to switch between transmit mode and receive mode operation. The FEM circuitry 630 may include a receive signal path and a transmit signal path. The receive signal path of the FEM circuitry 630 may include an LNA to amplify received RF signals and provide the amplified received RF signals as an output (e.g., to the RF circuitry 620). The transmit signal path of the FEM circuitry 630 may include a power amplifier (PA) to amplify input RF signals (e.g., provided by the RF circuitry 620), and one or more filters to generate RF signals for subsequent transmission (e.g., by one or more of the one or more antennas 632).

In some embodiments, the PMC 634 may manage power provided to the baseband circuitry 604. In particular, the PMC 634 may control power-source selection, voltage scaling, battery charging, or DC-to-DC conversion. The PMC 634 may often be included when the device 600 is capable of being powered by a battery, for example, when the device 600 is included in an EGE. The PMC 634 may increase the power conversion efficiency while providing desirable implementation size and heat dissipation characteristics.

FIG. 6 shows the PMC 634 coupled only with the baseband circuitry 604. However, in other embodiments, the PMC 634 may be additionally or alternatively coupled with, and perform similar power management operations for, other components such as, but not limited to, the application circuitry 602, the RF circuitry 620, or the FEM circuitry 630.

In some embodiments, the PMC 634 may control, or otherwise be part of, various power saving mechanisms of the device 600. For example, if the device 600 is in an RRC Connected state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used to execute Layer 3, Layer 2, or Layer 1 functionality, while processors of the application circuitry 602 may utilize data (e.g., packet data) received from these layers and further execute Layer 4 functionality (e.g., transmission communication protocol (TCP) and user datagram protocol (UDP) layers). As referred to herein, Layer 3 may include a radio resource control (RRC) layer, described in further detail below. As referred to herein, Layer 2 may include a medium access control (MAC) layer, a radio link control (RLC) layer, and a packet data convergence protocol (PDCP) layer, described in further detail below. As referred to herein, Layer 1 may include a physical (PHY) layer of a UE/RAN node, described in further detail below.

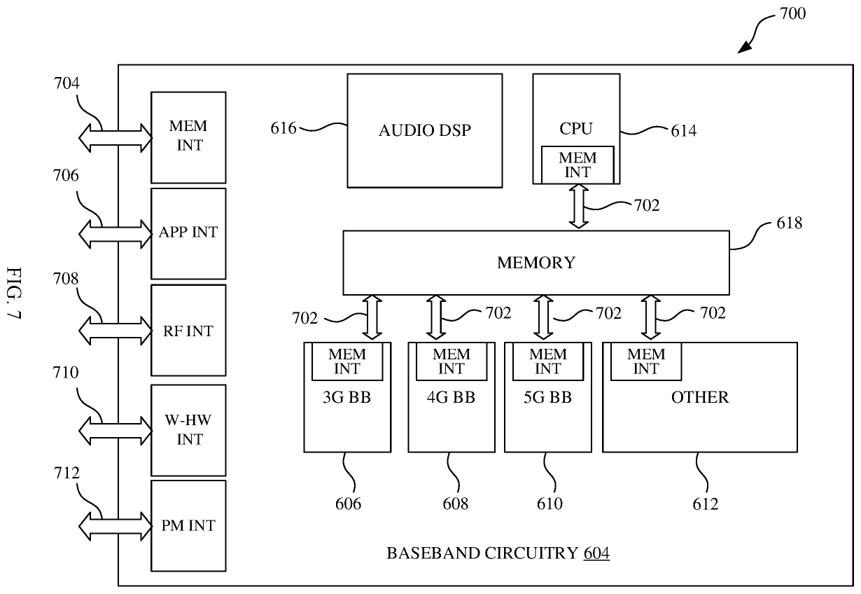

FIG. 7 illustrates example interfaces 700 of baseband circuitry in accordance with some embodiments. As discussed above, the baseband circuitry 604 of FIG. 6 may include 3G baseband processor 606, 4G baseband processor 608, 5G baseband processor 610, other baseband processor(s) 612, CPU 614, and a memory 618 utilized by said processors. As illustrated, each of the processors may include a respective memory interface 702 to send/receive data to/from the memory 618.

The baseband circuitry 704 may further include one or more interfaces to communicatively couple to other circuitries/devices, such as a memory interface 704 (e.g., an interface to send/receive data to/from memory external to the baseband circuitry 604), an application circuitry interface 706 (e.g., an interface to send/receive data to/from the application circuitry 602 of FIG. 6), an RF circuitry interface 708 (e.g., an interface to send/receive data to/from RF circuitry 620 of FIG. 6), a wireless hardware connectivity interface 710 (e.g., an interface to send/receive data to/from Near Field Communication (NFC) components, Bluetooth® components (e.g., Bluetooth® Low Energy), Wi-Fi® components, and other communication components), and a power management interface 712 (e.g., an interface to send/receive power or control signals to/from the PMC 634.

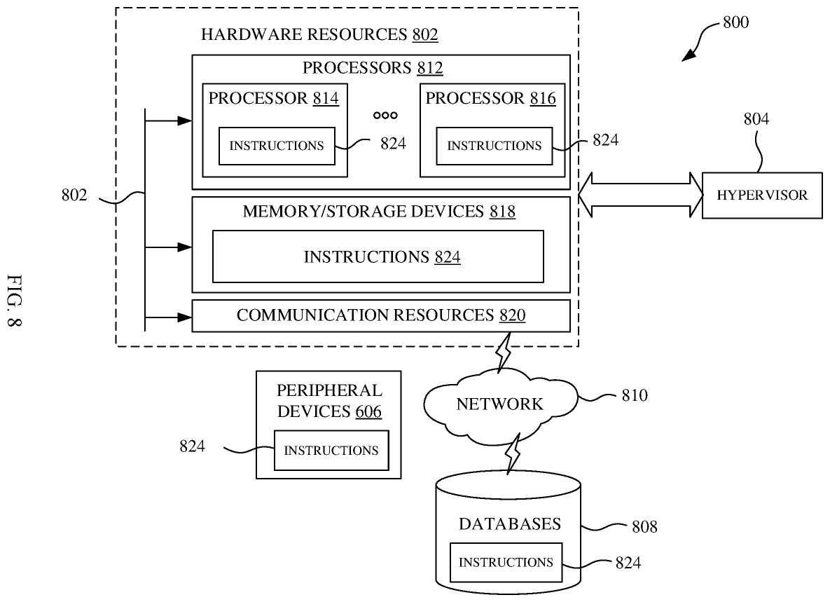

FIG. 8 is a block diagram illustrating components 800, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 802 including one or more processors 812 (or processor cores), one or more memory/storage devices 818, and one or more communication resources 820, each of which may be communicatively coupled via a bus 822. For embodiments where node virtualization (e.g., NFV) is utilized, a hypervisor 804 may be executed to provide an execution environment for one or more network slices/sub-slices to utilize the hardware resources 802.

The processors 812 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 814 and a processor 816.

The memory/storage devices 818 may include main memory, disk storage, or any suitable combination thereof. The memory/storage devices 818 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 820 may include interconnection or network interface components or other suitable devices to communicate with one or more peripheral devices 806 or one or more databases 808 via a network 810. For example, the communication resources 820 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 824 may include software, a program, an application, an applet, an app, or other executable code for causing at least any of the processors 812 to perform any one or more of the methodologies discussed herein. The instructions 824 may reside, completely or partially, within at least one of the processors 812 (e.g., within the processor's cache memory), the memory/storage devices 818, or any suitable combination thereof. Furthermore, any portion of the instructions 824 may be transferred to the hardware resources 802 from any combination of the peripheral devices 806 or the databases 808. Accordingly, the memory of the processors 812, the memory/storage devices 818, the peripheral devices 806, and the databases 808 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

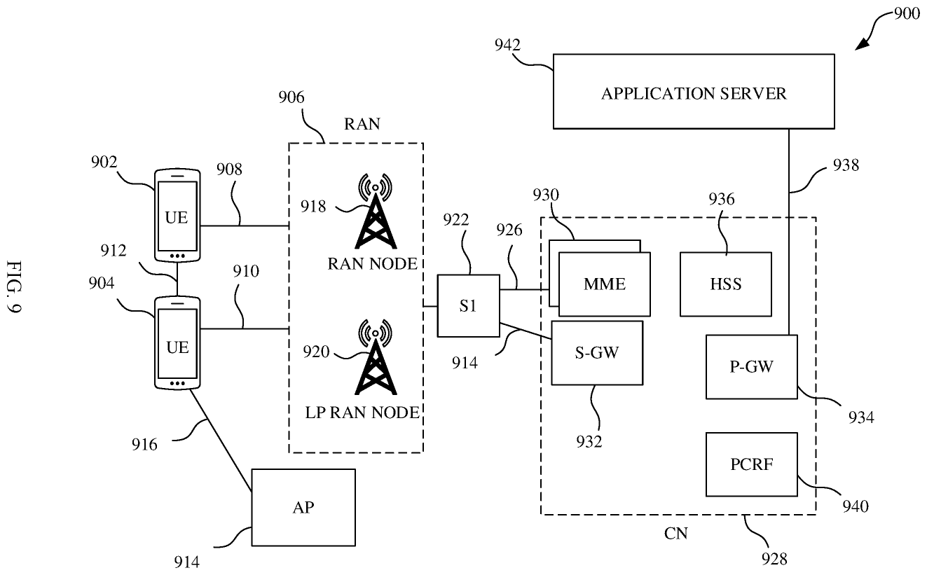

FIG. 9 illustrates an architecture of a system 900 of a network in accordance with some embodiments. The system 900 includes one or more user equipment (UE), shown in this example as a UE 902 and a UE 904. The UE 902 and the UE 904 are illustrated as smartphones (e.g., handheld touchscreen mobile computing devices connectable to one or more cellular networks), but may also include any mobile or non-mobile computing device, such as Personal Data Assistants (PDAs), pagers, laptop computers, desktop computers, wireless handsets, or any computing device including a wireless communications interface.

In some embodiments, any of the UE 902 and the UE 904 can include an Internet of Things (IoT) UE, which can include a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 902 and the UE 904 may be configured to connect, e.g., communicatively couple, with a radio access network (RAN), shown as RAN 906. The RAN 906 may be, for example, an Evolved ETniversal Mobile Telecommunications System (ETMTS) Terrestrial Radio Access Network (E-UTRAN), a NextGen RAN (NG RAN), or some other type of RAN. The UE 902 and the UE 904 utilize connection 908 and connection 910, respectively, each of which includes a physical communications interface or layer (discussed in further detail below); in this example, the connection 908 and the connection 910 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 902 and the UE 904 may further directly exchange communication data via a ProSe interface 912. The ProSe interface 912 may alternatively be referred to as a sidelink interface including one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 904 is shown to be configured to access an access point (AP), shown as AP 914, via connection 916. The connection 916 can include a local wireless connection, such as a connection consistent with any IEEE 802.11 protocol, wherein the AP 914 would include a wireless fidelity (WiFi®) router. In this example, the AP 914 may be connected to the Internet without connecting to the core network of the wireless system (described in further detail below).

The RAN 906 can include one or more access nodes that enable the connection 908 and the connection 910. These access nodes (ANs) can be referred to as base stations (BSs), NodeBs, evolved NodeBs (eNBs), next Generation NodeBs (gNB), RAN nodes, and so forth, and can include ground stations (e.g., terrestrial access points) or satellite stations providing coverage within a geographic area (e.g., a cell). The RAN 906 may include one or more RAN nodes for providing macrocells, e.g., macro RAN node 918, and one or more RAN nodes for providing femtocells or picocells (e.g., cells having smaller coverage areas, smaller user capacity, or higher bandwidth compared to macrocells), e.g., a low power (LP) RAN node such as LP RAN node 920.

Any of the macro RAN node 918 and the LP RAN node 920 can terminate the air interface protocol and can be the first point of contact for the UE 902 and the UE 904. In some embodiments, any of the macro RAN node 918 and the LP RAN node 920 can fulfill various logical functions for the RAN 906 including, but not limited to, radio network controller (RNC) functions such as radio bearer management, uplink and downlink dynamic radio resource management and data packet scheduling, and mobility management.

In accordance with some embodiments, the EGE 902 and the EGE 904 can be configured to communicate using Orthogonal Frequency-Division Multiplexing (OFDM) communication signals with each other or with any of the macro RAN node 918 and the LP RAN node 920 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can include a plurality of orthogonal sub carriers.

In some embodiments, a downlink resource grid can be used for downlink transmissions from any of the macro RAN node 918 and the LP RAN node 920 to the UE 902 and the UE 904, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid includes a number of resource blocks, which describe the mapping of certain physical channels to resource elements. Each resource block includes a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 902 and the UE 904. The physical downlink control channel (PDCCH) may carry information about the transport format and resource allocations related to the PDSCH channel, among other things. It may also inform the UE 902 and the UE 904 about the transport format, resource allocation, and H-ARQ (Hybrid Automatic Repeat Request) information related to the uplink shared channel. Typically, downlink scheduling (assigning control and shared channel resource blocks to the UE 904 within a cell) may be performed at any of the macro RAN node 918 and the LP RAN node 920 based on channel quality information fed back from any of the UE 902 and UE 904. The downlink resource assignment information may be sent on the PDCCH used for (e.g., assigned to) each of the UE 902 and the UE 904.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 906 is communicatively coupled to a core network (CN), shown as CN 928—via an S1 interface 922. In embodiments, the CN 928 may be an evolved packet core (EPC) network, a NextGen Packet Core (NPC) network, or some other type of CN. In this embodiment the S1 interface 922 is split into two parts: the S1-U interface 924, which carries traffic data between the macro RAN node 918 and the LP RAN node 920 and a serving gateway (S-GW), shown as S-GW 1132, and an S1-mobility management entity (MME) interface, shown as S1-MME interface 926, which is a signaling interface between the macro RAN node 918 and LP RAN node 920 and the MME(s) 930.

In this embodiment, the CN 928 includes the MME(s) 930, the S-GW 932, a Packet Data Network (PDN) Gateway (P-GW) (shown as P-GW 934), and a home subscriber server (HSS) (shown as HSS 936). The MME(s) 930 may be similar in function to the control plane of legacy Serving General Packet Radio Service (GPRS) Support Nodes (SGSN). The MME(s) 930 may manage mobility aspects in access such as gateway selection and tracking area list management. The HSS 936 may include a database for network users, including subscription-related information to support the network entities' handling of communication sessions. The CN 928 may include one or several HSS 936, depending on the number of mobile subscribers, on the capacity of the equipment, on the organization of the network, etc. For example, the HSS 936 can provide support for routing/roaming, authentication, authorization, naming/addressing resolution, location dependencies, etc.

The S-GW 932 may terminate the S1 interface 922 towards the RAN 906, and routes data packets between the RAN 906 and the CN 928. In addition, the S-GW 932 may be a local mobility anchor point for inter-RAN node handovers and also may provide an anchor for inter-3 GPP mobility. Other responsibilities may include lawful intercept, charging, and some policy enforcement.

The P-GW 934 may terminate an SGi interface toward a PDN. The P-GW 934 may route data packets between the CN 928 (e.g., an EPC network) and external networks such as a network including the application server 942 (alternatively referred to as application function (AF)) via an Internet Protocol (IP) interface (shown as IP communications interface 938). Generally, an application server 942 may be an element offering applications that use IP bearer resources with the core network (e.g., ETMTS Packet Services (PS) domain, LTE PS data services, etc.). In this embodiment, the P-GW 934 is shown to be communicatively coupled to an application server 942 via an IP communications interface 938. The application server 942 can also be configured to support one or more communication services (e.g., Voice-over-Internet Protocol (VOIP) sessions, PTT sessions, group communication sessions, social networking services, etc.) for the UE 902 and the UE 904 via the CN 928.

The P-GW 934 may further be a node for policy enforcement and charging data collection. A Policy and Charging Enforcement Function (PCRF) (shown as PCRF 940) is the policy and charging control element of the CN 928. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 940 may be communicatively coupled to the application server 942 via the P-GW 934. The application server 942 may signal the PCRF 940 to indicate a new service flow and select the appropriate Quality of Service (QoS) and charging parameters. The PCRF 940 may provision this rule into a Policy and Charging Enforcement Function (PCEF) (not shown) with the appropriate traffic flow template (TFT) and QoS class of identifier (QCI), which commences the QoS and charging as specified by the application server 942.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is a method for a first communication device, comprising: obtaining a first protocol data unit (PDU) set comprising multiple Radio Link Control (RLC) PDUs for transmission to a second communication device; in response to a determination that a first criterion is met for the first PDU set, identifying, from the first PDU set, at least one PDU for retransmission; and triggering an RLC retransmission for the at least one PDU to the second communication device.

Example 2 is the method of example 1, wherein the first criterion comprises at least one of the following: that an N^{th} PDU of the first PDU set has been transmitted, wherein N is a positive integer that is smaller than the size of the first PDU set; or that an M^{th} last PDU of the first PDU set has been transmitted, wherein M is a positive integer that is smaller than the size of the first PDU set.

Example 3 is the method of example 1, wherein the first criterion comprises at least one of the following: that a time of a first threshold has lapsed after a start point of the transmission of the first PDU set, wherein the first threshold is less than a valid time period for the transmission of the first PDU set; or that a remaining duration for the transmission of the first PDU set has fallen below a second threshold, wherein the second threshold is great than zero and less than the valid time period for the transmission of the first PDU set.

Example 4 is the method of any of examples 1-3, wherein the first criterion further comprises a number of ACK feedbacks received for the first PDU set is below a third threshold.

Example 5 is the method of example 1, wherein the first criterion comprises that a retransmission indication specifying the first PDU set is obtained from a Packet Data Convergence Protocol (PDCP) layer.

Example 6 is the method of example 1, wherein the first criterion comprises that a transmission or a retransmission is triggered for a second PDU set having dependency with the first PDU set.

Example 7 is the method of any of examples 1-6, wherein identifying at least one PDU for retransmission comprises: identifying a PDU from the first PDU set, for which no acknowledge (ACK) feedback is received, as a PDU for retransmission.

Example 8 is the method of any of examples 1-7, wherein identifying at least one PDU for retransmission comprises: in a case that the multiple PDUs have different priorities, identifying a PDU from the first PDU set and satisfying at least one of the following as a PDU for retransmission: the PDU is of a higher priority, the PDU has an important flag, or for the PDU no ACK feedback is received.

Example 9 is the method of example 7 or 8, wherein triggering a retransmission for the at least one PDU comprises causing the retransmission to be performed after a completion of the transmission of the first PDU set; and the method further comprising: in response to receiving an ACK feedback for a first PDU of the at least one PDU before retransmitting of the first PDU, forgoing the initiating of the retransmission for the first PDU.

Example 10 is the method of example 7 or 8, wherein the ACK feedback for a PDU comprises: an RLC ACK, an explicit ACK for a Hybrid Automatic Repeat Request (HARQ) transmission corresponding to the PDU, or an implicit ACK for the HARQ transmission corresponding to the PDU for an RLC AM mode, or an explicit ACK for a Hybrid Automatic Repeat Request (HARQ) transmission corresponding to the PDU, or an implicit ACK for the HARQ transmission corresponding to the PDU for an RLC UM mode.

Example 11 is the method of example 1, wherein the first criterion comprises that a retransmission indication specifying a start PDU is obtained from a Packet Data Convergence Protocol (PDCP) layer, and wherein identifying the at least one PDU for retransmission comprises: identifying a PDU, starting from the start PDU and within the first PDU set, for which no acknowledge (ACK) feedback is received, as a PDU for retransmission.

Example 12 is the method of example 1, wherein the first criterion comprises that a retransmission indication specifying a start PDU is obtained from a Packet Data Convergence Protocol (PDCP) layer, and wherein identifying at least one PDU for retransmission comprises: in a case that RLC Service data units (SDUs) corresponding to the multiple PDUs are indicated with different priorities, identifying a PDU starting from the start PDU and within the first PDU set and satisfying at least one of the following as a PDU for retransmission: the PDU is of a higher priority, the PDU has an important flag, or for the PDU no ACK feedback is received.

Example 13 is the method of example 1, wherein the first criterion comprises that a retransmission indication specifying one or more PDU is obtained from a Packet Data Convergence Protocol (PDCP) layer, and wherein identifying the at least one PDU for retransmission comprises identifying the one or more PDU specified in the retransmission indication as the at least one PDU for retransmission.

Example 14 is the method of any of examples 1-13, wherein triggering an RLC retransmission for the at least one PDU comprises: triggering the retransmission immediately, or triggering the retransmission upon an expiration of a t-PollRetransmit timer.

Example 15 is the method of any of examples 1-14, further comprising in a case that there is no UL grant and that the first PDU set is indicated as urgent, transmitting, to the second communication device, a Scheduling Request (SR), a Buffer Status Report (BSR) or an MAC CE as an urgent request before the expiration of a valid time period set for the transmission of the first PDU set.

Example 16 is the method of example 15, wherein the SR is a dedicated SR resource configured for the urgent request.

Example 17 is the method of example 15, wherein the BSR includes at least one of a channel information, a data amount, or a remaining duration.

Example 18 is an apparatus comprising one or more processors configured to perform steps of the method according to any of examples 1-17.

Example 19 is a computer readable medium having computer programs stored thereon which, when executed by one or more processors, cause an apparatus to perform steps of the method according to any of examples 1-17.

Example 20 is a computer program product comprising computer programs which, when executed by one or more processors, cause an apparatus to perform steps of the method according to any of examples 1-17.

Example 21 is an apparatus for a communication device is provided that includes means for performing steps of the method according to perform steps of the method according to the present disclosure.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-20. (canceled)

21. A method comprising:
obtaining a first protocol data unit (PDU) set that includes a plurality of Radio Link Control (RLC) PDUs for transmission to a communication device;
in response to a determination that a first criterion is met for the first PDU set, identifying, from the first PDU set, at least one PDU for retransmission; and
triggering an RLC retransmission for the at least one PDU to the communication device.

22. The method of claim 21, wherein the first criterion comprises at least one of the following:
that an N^{th} PDU of the first PDU set has been transmitted, wherein N is a positive integer that is smaller than a size of the first PDU set; or
that an M^{th} last PDU of the first PDU set has been transmitted, wherein M is a positive integer that is smaller than a size of the first PDU set.

23. The method of claim 21, wherein the first criterion comprises at least one of the following:
that a time of a first threshold has lapsed after a start point of the transmission of the first PDU set, wherein the first threshold is less than a valid time period for the transmission of the first PDU set; or
that a remaining duration for the transmission of the first PDU set has fallen below a second threshold, wherein the second threshold is greater than zero and less than the valid time period for the transmission of the first PDU set.

24. The method of claim 21, wherein the first criterion further comprises a number of ACK feedbacks received for the first PDU set is below a threshold.

25. The method of claim 21, wherein the first criterion comprises that a retransmission indication specifying the first PDU set is obtained from a Packet Data Convergence Protocol (PDCP) layer.

26. The method of claim 21, wherein the first criterion comprises that a transmission or a retransmission is triggered for a second PDU set having dependency with the first PDU set.

27. The method of claim 21, wherein identifying at least one PDU for retransmission comprises:
identifying a PDU from the first PDU set, for which no acknowledge (ACK) feedback is received.

28. The method of claim 27, wherein the ACK feedback for a PDU comprises: an RLC ACK, an explicit ACK for a Hybrid Automatic Repeat Request (HARQ) transmission corresponding to the PDU, an implicit ACK for a HARQ transmission corresponding to the PDU for an RLC AM mode, an explicit ACK for a HARQ transmission corresponding to the PDU, or an implicit ACK for a HARQ transmission corresponding to the PDU for an RLC UM mode.

29. The method of claim 21, wherein the plurality of RLC PDUs have different priorities and identifying at least one PDU for retransmission comprises:
identifying a PDU from the first PDU set that satisfies at least one of the following: the PDU is of a higher priority than other PDUs in the first PDU set or the PDU has an important flag.

30. The method of claim 29, wherein triggering a retransmission for the at least one PDU comprises causing the retransmission to be performed after a completion of the transmission of the first PDU set and the method further comprises:
in response to receiving an ACK feedback for a first PDU of the at least one PDU and before retransmitting of the first PDU, forgoing retransmission of the first PDU.

31. One or more non-transitory, computer-readable media having instructions that, when executed, cause processor circuitry to:
obtain a first protocol data unit (PDU) set that includes a plurality of Radio Link Control (RLC) PDUs for transmission to a communication device;
in response to a determination that a first criterion is met for the first PDU set, identify, from the first PDU set, at least one PDU for retransmission; and
trigger an RLC retransmission for the at least one PDU to the communication device.

32. The one or more non-transitory, computer-readable media of claim 31, wherein the first criterion comprises that a retransmission indication specifying a start PDU is obtained from a Packet Data Convergence Protocol (PDCP) layer, and to identify the at least one PDU for retransmission the processor circuitry is to:
identify a PDU, starting from the start PDU and within the first PDU set, for which no acknowledge (ACK) feedback is received.

33. The one or more non-transitory, computer-readable media of claim 31, wherein the first criterion includes that a retransmission indication specifying a start PDU is obtained from a Packet Data Convergence Protocol (PDCP) layer, RLC Service data units (SDUs) corresponding to the plurality of RLC PDUs are indicated with different priorities, and to identify at least one PDU for retransmission the processor circuitry is to:
identify a PDU starting from the start PDU and within the first PDU set that satisfies at least one of the following: the PDU is of a higher priority that other PDUs of the PDU set, or the PDU has an important flag.

34. The one or more non-transitory, computer-readable media of claim 31, wherein the first criterion includes that a retransmission indication specifying one or more PDUs is obtained from a Packet Data Convergence Protocol (PDCP) layer, to identify the at least one PDU for retransmission the processor circuitry is to identify the one or more PDUs specified in the retransmission indication as the at least one PDU for retransmission.

35. The one or more non-transitory, computer-readable media of claim 31, wherein to trigger an RLC retransmission for the at least one PDU the processor is to: trigger the retransmission immediately, or trigger the retransmission upon an expiration of a t-PollRetransmit timer.

36. The one or more non-transitory, computer-readable media of claim 31, wherein there is no UL grant, the first PDU set is indicated as urgent, and the instructions, when executed, further cause the processor circuitry to:
transmit, to the communication device, a Scheduling Request (SR), a Buffer Status Report (BSR), or an MAC CE as an urgent request before an expiration of a valid time period set for the transmission of the first PDU set.

37. The one or more non-transitory, computer-readable media of claim 36, wherein the processor circuitry is to transmit an SR using a dedicated SR resource configured for the urgent request.

38. The one or more non-transitory, computer-readable media of claim 36, wherein the processor circuitry is to transmit a BSR that includes at least one of a channel information, a data amount, or a remaining duration.

39. An apparatus comprising:
processor circuitry to:
obtain a first protocol data unit (PDU) set that includes a plurality of Radio Link Control (RLC) PDUs for transmission to a communication device;
in response to a determination that a first criterion is met for the first PDU set, identify, from the first PDU set, at least one PDU for retransmission; and
trigger an RLC retransmission for the at least one PDU to the communication device; and
interface circuitry coupled with the processor circuitry to enable communication.

40. The apparatus of claim 39, wherein the first criterion comprises that a retransmission indication specifying a start PDU is obtained from a Packet Data Convergence Protocol (PDCP) layer, and to identify the at least one PDU for retransmission the processor circuitry is to:
identify a PDU, starting from the start PDU and within the first PDU set, for which no acknowledge (ACK) feedback is received.
